(19) United States
(12) Patent Application Publication
(10) Pub. No.: US 2002/0171423 A1
(43) Pub. Date: Nov. 21, 2002

(54) Method for producing spatially encoded measuring signals

(75) Inventor: Michael Heidenreich, Karlsruhe (DE)

Correspondence Address: Kohler Schmid + Partner, Ruppmannstr. 27, Stuttgart, D-70565, DE

(73) Assignee: Bruker BioSpin MRI GmbH, Ettlingen (DE)

(21) Appl. No.: 10/132,573

(22) Filed: Apr. 26, 2002

(30) Foreign Application Priority Data
May 16, 2001 (DE) 101 23 772.3

(51) Int. Cl. G01V 3/00

(52) U.S. Cl. 324/307; 324/309

(57) ABSTRACT

In a method for producing spatially encoded measuring signals of nuclear magnetic resonance from a measuring object, wherein nuclear spins are excited in the measuring object through irradiation of radio frequency (RF) pulses, encoding in reciprocal spatial space (k space) is generated through application of a phase gradient in n dimensions and a magnetic resonance signal from the measuring object is then recorded, wherein k space is scanned in a desired region between kₘᵢₙ and kₘₐₓ through corresponding repetition of the excitation, encoding and recording steps with different respective phase gradients, and wherein the individual magnetic resonance signals are each associated with a certain weighting (acquisition filter) which is predetermined by the dependence of a desired spatial response function, the time T_{R}(kn) between the start of the (n−1)th excitation step for scanning the measuring signal which corresponds to the point kₙ₋₁ in k space and the start of the nth excitation step for scanning the measuring signal which corresponds to the point kₙ in k space, is selected such that the signal intensity in the nth recording step corresponds to the weighting predetermined by the acquisition filter in dependence on the instantaneous position kₙ in k space which is to be scanned. The filter is already realized during data recording and can be effected with only one accumulation.

This application claims Paris Convention priority of DE 101 23 772.3 filed May 16, 2001 the complete disclosure of which is hereby incorporated by reference.

### BACKGROUND OF THE INVENTION

The invention concerns a method for producing spatially encoded measuring signals of nuclear magnetic resonance from a measuring object, wherein nuclear spins are excited in the measuring object through irradiation of radio frequency (RF) pulses, encoding in reciprocal position space (k space) is generated by applying a phase gradient in n dimensions, and a magnetic resonance signal is subsequently recorded from the measuring object, wherein k space is scanned in a desired region between kₘᵢₙ and kₘₐₓ through corresponding repetition of the excitation, encoding and recording steps each with different phase gradients and wherein the individual magnetic resonance signals are associated with a certain weighting in the recording steps (acquisition filter) which is predetermined by the dependence of a desired spatial response function.

An arrangement of this type is known from Kienlin, “Empfindlichkeit und Ortsauflösung in der lokalisierten NMR-Spektroskopie”, postdoctoral thesis 1996.

This document discloses changing the shape of the spatial response function through application of filters in k space. These filters can already be used for data recording or later for data processing. The data recording is weighted when the number of signal accumulations per phase encoding step is varied during data recording in dependence on the position in k space. Cosine and Hanning functions are mainly used for filtering or weighting of the data recording. They broaden the full width at half maximum of the main maximum of the spatial response function, but also effectively suppress the strength of the side maxima of the spatial response function outside the center which is necessarily caused by incomplete scanning of k space. To obtain constant spatial resolution with e.g. a Hanning filter, the number of phase encodings is doubled in each corresponding direction of k space during weighted data recording, however less measurements for high phase encoding k values are accumulated. This method can be used as an acquisition filter on the condition that a large number of accumulations takes place.

This method cannot be used for normal imaging since the number of repetitions is typically in the region of 1 to 4. The filter function is therefore not sufficiently defined. The filter function can, if at all, be realized only in discrete steps since the step size is determined by the number of accumulations.

It is therefore the object of the invention to modify the above-mentioned method such that any continuous spatial response function can be realized and that the acquisition filter can be also used without signal accumulation.

### SUMMARY OF THE INVENTION

This object is achieved in a surprisingly simple and technically straightforward manner in that the time t_{R}(kₙ) between the start of the (n−1)th excitation step for scanning of the measuring signal which corresponds to the point kₙ₋₁ in k space, and the start of the nth excitation step for scanning the measuring signal which corresponds to the point kₙ in k space is selected such that the signal intensity in the nth recording step corresponds to the weighting predetermined by the acquisition filter in dependence on the instantaneous position kₙ.

The filter is already realized during data recording. The filter function can be effected with high precision over a large range. This is possible even if only one single accumulation is carried out in the experiment. All implementations of recording strategies weighted by k space mentioned above are based on the variation of the number of repetitions. A well defined filter function requires a large maximum number of repetitions of the experiment for these methods. Compared to methods which realize weighting by special k space trajectories, the present method does not require demanding processing (“regridding”) of the measuring data.

This object is also achieved in that the excitation angle αₙ in the nth excitation step for scanning the measuring signal which corresponds to the point kₙ in k space, is selected such that the signal intensity in the nth recording step corresponds to the weighting predetermined by the acquisition filter in dependence on the instantaneous position kₙ in k space which is to be scanned. This produces a constant repetition rate wherein nested data recordings are facilitated e.g. for “multi-slice imaging” techniques.

The calculation of the respectively required excitation angle is difficult since the respectively required excitation angle depends on all previous excitation angles. Moreover, currently used apparatus do not meet the hardware preconditions for varying the excitation angle. For this reason the method is technically very demanding. In contrast to the above-mentioned solution of the object, change of the excitation angles generally reduces the ratio between signal/time interval which disadvantageously prolongs the effective measuring time.

In a preferred method variant, n-dimensional local encoding is carried out through application of n orthogonal phase gradients. This permits carrying out so-called spectroscopic imaging (SI), preferably 2-D-SI or 3-D-SI. The inventive method is particularly advantageous since only a few phase encodings can usually be carried out and for this reason, the spatial response function causes strong artifacts with unweighted data recording.

It is advantageous to apply an orthogonal read gradient in addition to the n-dimensional phase encoding during the recording steps. This measure produces gradient echo signals. An advantageous application is the imaging method, in particular tomography. With additional n-dimensional local encoding, 2-D or 3-D tomography is particularly facilitated.

During the excitation steps, sequences of several successive RF pulses are preferably radiated per phase encoding step which produces spin echo or stimulated echo signals.

In an embodiment of the method, slice-selective RF pulses are applied in combination with a slice selection gradient. This measure permits recording of a 2-D image or carrying out of 2-D-SI with slice selection.

In a further embodiment of the method, one or more spoiler gradients are switched after each cycle of RF excitation, phase encoding and data recording. These spoiler gradients prevent stimulated echo signals in the subsequent cycles.

In an inventive method variant, band-limited selective RF pulses are irradiated during the excitation steps. In this fashion, the nuclear spins of a certain substance in the measuring object are chemically selectively excited. Application of a read gradient permits Chemical Shift Selective Imaging. Without read gradient, spectroscopic imaging can be carried out with suppression of H₂O signals.

It is particularly advantageous to select the acquisition filter such that, in contrast to unfiltered data recording, a local resolution with reduced image artifacts of the measuring data can be achieved through optimizing the spatial response function.

An alternative method variant is characterized in that, in contrast to unfiltered data recording, the signal-to-noise (S/N) ratio is increased normalized to a total recording time interval. Advantageously, the measuring time can be shortened for a given S/N ratio.

In a further alternative method variant, the acquisition filter is a Hanning filter. This filter produces a good balance between the enlargement of the full width half maximum of the main peak and the intensity of the side maxima of the spatial response function.

In an embodiment of the method, a post processing filter is applied to the recorded measuring data after data recording. This permits e.g. later generation of an isotropic spatial response function when phase gradient(s) and read gradient are combined.

In a further method variant, several measuring signals are accumulated at least for some points in the region of k space to be scanned. Accumulation of several measuring signals produces optimum implementation of the desired signal weighting and the S/N ratio is also improved. The inventive method can also be advantageously used without any signal accumulation, e.g. with only one recording passage per k space point.

In a further development of the method, the number of the signal accumulations is varied in dependence on the respective currently scanned position kₙ in k space. The same filter function can be effected through frequent accumulations or correspondingly longer repetition times per recording step for individual k space points. This produces precise optimization of the S/N ratio per k space point.

Further advantages can be extracted from the drawings and the description. The features mentioned above and below can be used in accordance with the invention either individually or collectively in any arbitrary combination. The embodiments shown and described are not to be understood as exhaustive enumerations but rather have exemplary character for describing the invention.

The invention is shown in the drawing and further explained by means of embodiments.

### BRIEF DESCRIPTION OF THE DRAWING

FIG. 1a shows weighted data recording in the reciprocal position space through variation of the repetition time;

FIG. 1b shows weighted data recording in reciprocal position space through variation of the excitation angle;

FIG. 2 shows weighted data recording in reciprocal position space through variation of the repetition time;

FIG. 3 shows a profile through a resolution phantom; and

FIG. 4a shows recording of a recording phantom with weighted data recording;

FIG. 4b shows recording of the recording phantom of FIG. 4a with conventional data recording;

FIG. 4c shows a cross-section through the belly region of a rat with weighted data recording;

FIG. 4d shows a cross-section through the belly region of a rat of FIG. 4c with conventional data recording.

### DESCRIPTION OF THE PREFERRED EMBODIMENT

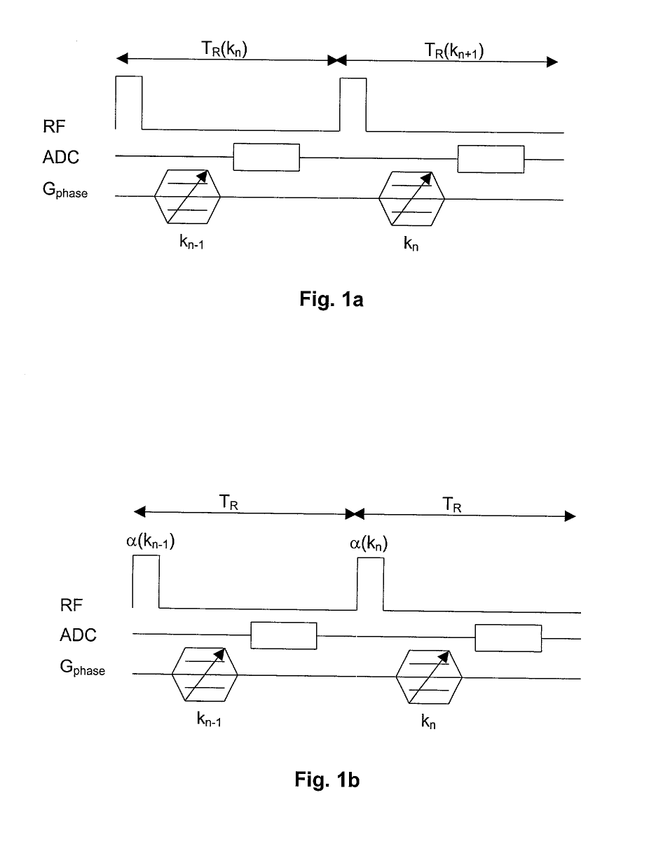

FIG. 1a shows weighted data recording in reciprocal position space through variation of the repetition time T_{R}(k). The excitation pulses with constant excitation angle are indicated at RF, the data recording at ADC and phase encoding by means of phase gradients at Gₚₕₐₛₑ. The basis of this MR recording strategy is weighting of the measured data points already during data recording using a well-defined filtering function. Weighting is effected by a repetition time T_{R}(k) which depends on the instantaneous scanning point of the reciprocal position space (k space). Data points which scan high spatial frequencies (large values in k space) are recorded with a short repetition time and the center of k space is scanned with a long repetition time. Since the spin system is completely or partially saturated during the entire data recording, the choice of the repetition time determines the signal intensity of the subsequent excitation. The time saved through short repetition times during scanning of high k values compared to recording with constant repetition rate can be used either to improve the signal-to-noise ratio (more accumulations) or to scan k space over a larger region.

FIG. 1b shows an alternative weighted data recording in reciprocal position space through variation of the excitation angle α(kₙ). Variation of the excitation angle α(Kₙ) varies the duration or intensity of the excitation pulse.

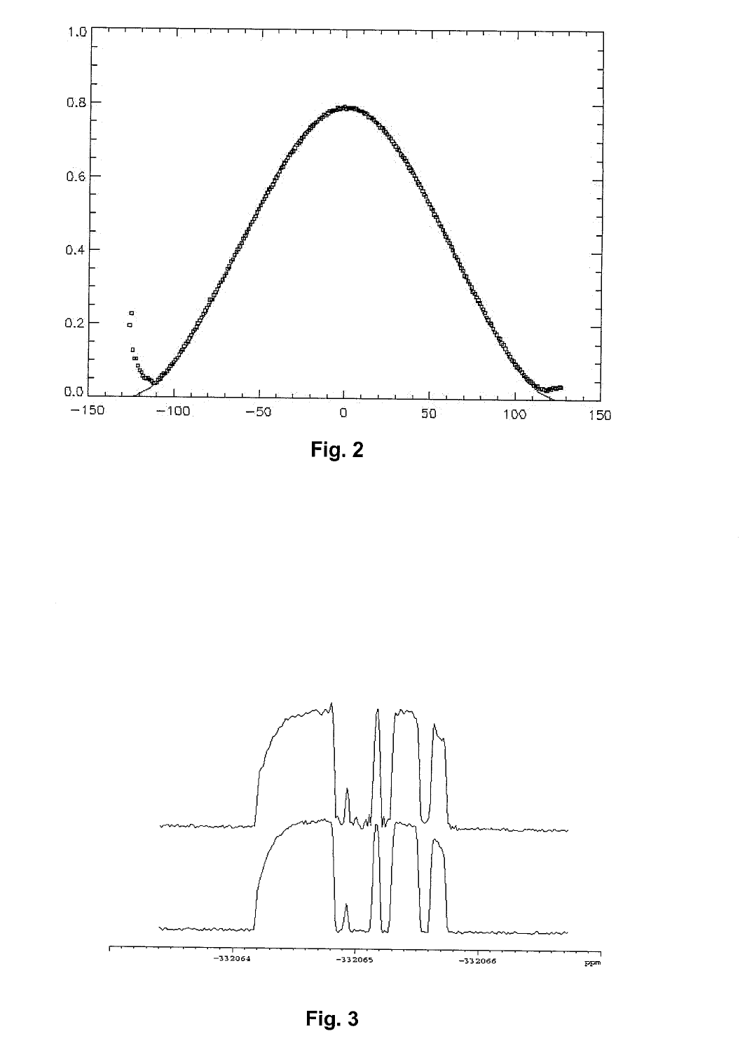

FIG. 2 shows a weighted data recording in reciprocal position space through variation of the repetition time. A comparison between the predetermined weighting function f(k) (solid line=Hanning filter) and the signal intensity measured in the experiment (points) is shown as a function of the position in k space (256 phase encoding steps, NS=1). The k space dependent repetition time was calculated according to the formula T_{R}(k)=−T₁ ln(1−αƒ(k)) for α=0.8 (the spin system is relaxed to not less than 80% at zero passage in k space). This calculation method is based on the assumption that the spin system is completely saturated after each cycle of excitation, phase encoding and data recording and that the longitudinal magnetization available at the time of the subsequent excitation builds up during the repetition time through longitudinal relaxation (analogous to “saturation recovery”). Deviation of the first points from the calculated curve can be explained by the unsaturated initial state of the spin system at the start of the experiment and could be prevented by implementing “dummy scans” before the first data recording. The minimum achievable signal intensity is given by the duration of a sequence of excitation, phase encoding and data recording and leads to the deviations of the measuring points from the theoretical values when scanning high spatial frequencies.

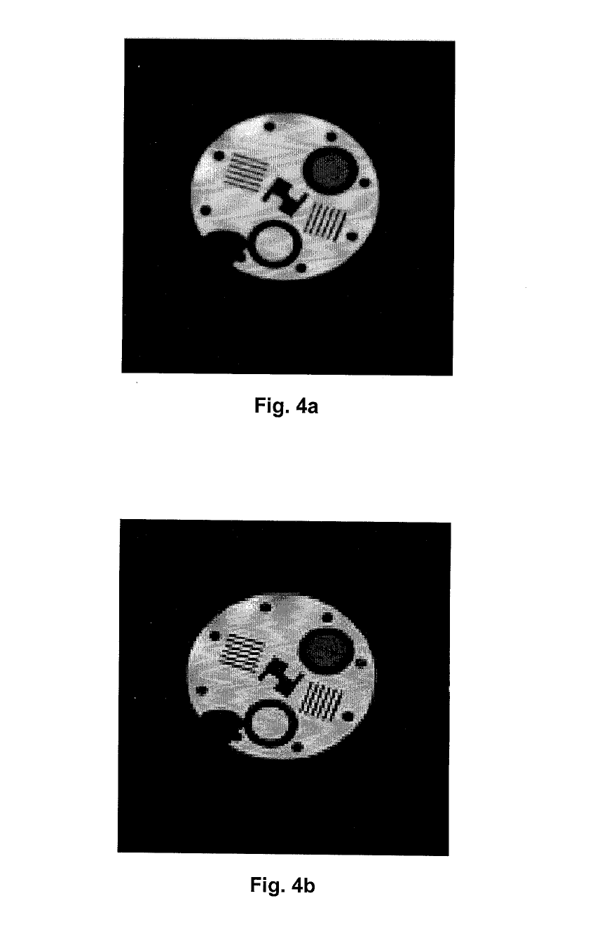

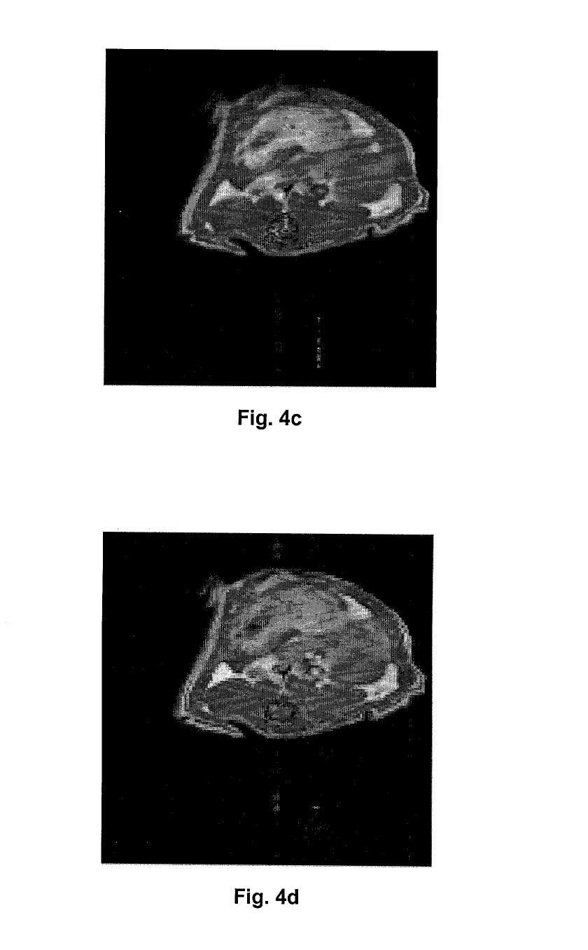

A Hanning filter was implemented in a 2D spin echo spin warp imaging sequence with slice selection and compared to a conventional experiment with constant repetition time (index c). The other experimental conditions of both experiments were the same. Spoiler gradients were implemented to avoid stimulated echo signals. The variable repetition times were calculated under the boundary conditions of identical spatial resolution (Nₚ^{acq weighted}=2Nₚ^{conventional} which produces good matching of the full width at half maxima of the main maximum for weighted and unweighted data recording) and identical total recording time, analogous to the results of FIG. 2. The results are shown in FIGS. 3 and 4a to 4d.

FIG. 3 shows profiles through a resolution phantom. The top portion shows unweighted data recording. The typical Gibb's artifacts at the edges of the object are clearly shown. The bottom portion shows weighted data recording with the inventive method (identical nominal spatial resolution, identical recording time). The signal-to-noise ratio is slightly improved in the weighted data recording (factor 1.1).

FIGS. 4a to 4d show 2D spin echo spin warp recordings with slice selection and spoiler gradients of respectively identical objects, recorded at 4,7 Tesla. FIG. 4a and FIG. 4c show weighted data recordings. FIG. 4b and FIG. 4d are conventional data recordings. Both comparisons have the same respective local resolution and recording times. FIGS. 4a and 4b show resolution phantoms. FIGS. 4c and 4d show cross-sections through the belly region of a rat. The unweighted image clearly shows the Gibb's artifacts which partially propagate through large regions of the image and produce apparent structures and contrasts which cannot be substantiated by the known properties of the investigational object.

I claim:

1. A method for producing spatially encoded measuring signals of nuclear magnetic resonance from a measuring object wherein nuclear spins are excited in the measuring object through irradiation of radio frequency (RF) pulses, encoding in reciprocal position space (k space) is generated through application of a phase gradient in n dimensions, and a magnetic resonance signal from the measuring object is subsequently recorded, wherein k space is scanned in a desired region between kₘᵢₙ and kₘₐₓ through corresponding repetition of the excitation, encoding and recording steps with different respective phase gradients, and wherein, in the recording steps, the individual magnetic resonance signals are associated with a certain weighting (acquisition filter) which is predetermined by a dependence of a desired spatial response function, the method comprising the step of:
selecting a time T_{R}(kₙ) between a start of an (n−1)th excitation step for scanning the measuring signal which corresponds to a point kₙ−1 in k space and a start of an nth excitation step for scanning the measuring signal which corresponds to a point kₙ in k space, such that a signal intensity in said nth recording step corresponds to the weighting predetermined by the acquisition filter in dependence on an instantaneous position kₙ in k space which is to be scanned.

2. The method of claim 1, wherein an n-dimensional spatial encoding is effected through application of n orthogonal phase gradients.

3. The method of claim 1, wherein an orthogonal read gradient is applied during the recording steps in addition to n-dimensional phase encoding.

4. The method of claim 1, wherein each sequence of excitation steps for scanning a point in k space is supplemented by one or more spoiler gradients.

5. The method of claim 1, wherein during excitation steps, sequences of several sequential RF pulses are irradiated per encoding step phase.

6. The method of claim 1, wherein slice-selective RF pulses are applied together with a slice selection gradient.

7. The method of claim 1, wherein band-limited selective RF pulses are irradiated during excitation steps.

8. The method of claim 1, wherein the acquisition filter is selected to achieve a local resolution of measuring data with reduced image artifacts compared to unfiltered data recording, through optimization of a local response function.

9. The method of claim 1, wherein the acquisition filter is selected to increase the signal-to-noise ratio, normalized to a total recording time interval, compared to that of unfiltered data recording.

10. The method of claim 1, wherein the acquisition filter is a Hanning filter.

11. The method of claim 1, wherein, after data recording, a post processing filter is applied to recorded measuring data.

12. The method of claim 1, wherein several measuring signals are accumulated at least for some points in a region of k space which is to be scanned.

13. The method of claim 1, wherein a number of signal accumulations is varied in dependence on a respective currently scanned position kₙ in k space.

14. A method for producing spatially encoded measuring signals of magnetic resonance from a measuring object, wherein nuclear spins are excited in the measuring object through irradiation of radio frequency (RF) pulses, encoding in reciprocal spatial space (k space) is generated through application of a phase gradient in n dimensions, and a magnetic resonance signal from the measuring object is then recorded, wherein k space is scanned in a desired region between kₘᵢₙ and kₘₐₓ through corresponding repetition of the excitation, encoding and recording steps with different respective phase gradients and wherein, in the recording steps, the individual magnetic resonance signals are associated with a certain weighting (acquisition filter) which is predetermined by a dependence of a desired spatial response function, the method comprising the steps of:
selecting an excitation angle αₙ in the nth excitation step for scanning the measuring signal which corresponds to a point kₙ in k space such that a signal intensity in said nth recording step corresponds to the weighting predetermined by the acquisition filter in dependence on am instantaneous position kn in k space.

15. The method of claim 14, wherein an n-dimensional local encoding is effected through application of n orthogonal phase gradients.

16. The method of claim 14, wherein an orthogonal read gradient is applied during the recording steps in addition to n-dimensional phase encoding.

17. The method of claim 14, wherein each sequence of excitation steps for scanning a point in k space is supplemented by one or more spoiler gradients.

18. The method of claim 14, wherein during excitation steps, sequences of several sequential RF pulses are irradiated per encoding step phase.

19. The method of claim 14, wherein slice-selective RF pulses are applied together with a slice selection gradient.

20. The method of claim 14, wherein band-limited selective RF pulses are irradiated during excitation steps.
